(19) United States
(12) Patent Application Publication
(10) Pub. No.: US 2025/0388115 A1
(43) Pub. Date: Dec. 25, 2025

(54) VEHICLE TO VEHICLE CHARGING SERVICES

(71) Applicant: INTERNATIONAL BUSINESS MACHINES CORPORATION, Armonk, NY (US)

(72) Inventors: Zhan Peng Huo, Beijing (CN); Yan Fei Qin, BEIJING (CN); Jia Liu, BEIJING (CN); Jiu Chang Du, Beijing (CN); Su Liu, Austin, TX (US)

(21) Appl. No.: 18/753,254

(22) Filed: Jun. 25, 2024

(51) Int. Cl. B60L 53/66; B60L 53/12; B60L 53/14; B60L 53/57; B60L 53/67

(52) U.S. Cl. CPC B60L 53/665; B60L 53/12; B60L 53/14; B60L 53/57; B60L 53/67; B60L 2240/72

(57) ABSTRACT

A computer-implemented method may include collecting charging data from a plurality of electric vehicles (EV); analyzing charging demands and charging availability of the plurality of EVs from the charging data; identifying an EV providing charging service and an EV requiring charging service from the plurality of EVs based on the analyzing; matching the EV providing charging service and the EV requiring charging service; determining a location for the EV requiring charging service to receive charging service from the EV providing charging service; communicating a charging task comprising the location to the EV providing charging service; and instructing the EV providing charging service to travel to the location.

### BACKGROUND

Aspects of the present invention generally relate to a smart vehicle-to-vehicle charging (SV2VC) service and, more particularly, to an SV2VC service including a data structure for tracking, saving, and processing SV2VC data.

Electric vehicles (EV) offer driving ranges practical for everyday use. EV travel range may reach approximately 300 miles (480 kilometers) on a single EV battery charge.

### SUMMARY

In a first aspect of the invention, there is a computer-implemented method including: collecting charging data from a plurality of electric vehicles (EV); analyzing charging demands and charging availability of the plurality of EVs from the charging data; identifying an EV providing charging service and an EV requiring charging service from the plurality of EVs based on the analyzing; matching the EV providing charging service and the EV requiring charging service; determining a location for the EV requiring charging service to receive charging service from the EV providing charging service; communicating a charging task comprising the location to the EV providing charging service; and instructing the EV providing charging service to travel to the location.

In another aspect of the invention, there is a computer program product including one or more computer readable storage media having program instructions collectively stored on the one or more computer readable storage media. The program instructions are executable to: collect charging data from a plurality of electric vehicles (EV); analyze charging demands and charging availability of the plurality of EVs from the charging data; identify an EV providing charging service and an EV requiring charging service from the plurality of EVs based on the analyzing; match the EV providing charging service and the EV requiring charging service; determine a location for the EV requiring charging service to receive charging service from the EV providing charging service; communicate a charging task comprising the location to the EV providing charging service; and instruct the EV providing charging service to travel to the location.

In another aspect of the invention, there is a system including a processor set, one or more computer readable storage media, and program instructions collectively stored on the one or more computer readable storage media. The program instructions are executable to: collect charging data from a plurality of electric vehicles (EV); analyze charging demands and charging availability of the plurality of EVs from the charging data; identify an EV providing charging service and an EV requiring charging service from the plurality of EVs based on the analyzing; match the EV providing charging service and the EV requiring charging service; determine a location for the EV requiring charging service to receive charging service from the EV providing charging service; communicate a charging task comprising the location to the EV providing charging service; and instruct the EV providing charging service to travel to the location.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary framework in accordance with aspects of the present invention.

FIG. 3 shows a block diagram of an exemplary framework in accordance with aspects of the present invention.

FIG. 4 shows a block diagram of an exemplary framework in accordance with aspects of the present invention.

FIG. 5 shows a block diagram of an exemplary environment in accordance with aspects of the present invention.

FIG. 6A shows an exemplary environment in accordance with aspects of the present invention.

FIG. 6B shows a table of smart vehicle-to-vehicle charging service data in accordance with aspects of the present invention.

FIG. 7A shows an exemplary environment in accordance with aspects of the present invention.

FIG. 7B shows a table of smart vehicle-to-vehicle charging service data in accordance with aspects of the present invention.

FIG. 8 shows a flowchart of an exemplary method in accordance with aspects of the present invention.

### DETAILED DESCRIPTION

Aspects of the present invention generally relate to a smart vehicle-to-vehicle charging (SV2VC) service and, more particularly, to an SV2VC service including a data structure for tracking, saving, and processing SV2VC data. In embodiments, aspects of the present invention provide a method, system, and computer program product for SV2VC to facilitate and benefit an EV providing charging service and an EV requiring charging service. In embodiments, aspects of the present invention take an SV2VC service into account to analyze a service profile and a user profile to suggest an optimal charging service for users to satisfy their travel options. In this manner, implementations of the present invention provide wired or wireless charging by an EV providing charge to at least one other EV. In embodiments, a charging cost can be paid to the EV providing charging service from the EV requiring charging service, and the EV providing charging service can be rewarded with a charging discount or equivalent credit from an SV2VC server.

Modern electric vehicles offer longer driving ranges, making them more practical for everyday use. EV driving range is typically not far enough for long-distance travel. Charging time for EVs is also typically longer in comparison to refueling a conventional internal combustion vehicle. Accordingly, improving charging speeds and reducing the time required for a full charge is advantageous for enhancing the user experience and convenience of EV charging. For example, one of the primary challenges is the need for widespread and accessible charging infrastructure. Currently, a portable charging vehicle station can provide portable chargers to the end user. However, portable charging stations have very limited capacity and are not convenient. Providing flexible EV charging options and expanding the network of charging stations, including fast-charging options, is crucial to support the growing number of EVs on the road.

Aspects of the present invention include an SV2VC system configured to provide flexible and timely charging of EVs. Aspects of the present invention intelligently utilize remaining battery of other EVs to charge a specific EV. Aspects of the present invention provide a method to find the nearest charging power source when an EV battery is low. Aspects of the present invention intelligently pair an EV requiring charging service with an EV providing the charging service.

A method of SV2VC with Internet of things (IoT) data analysis for automatically charging EVs with enhanced optimal charging service may include: monitoring and collecting IoT data of EV battery conditions, user routing plans, current location, and target destination from all involved EVs in a vehicle-to-everything (V2X) network; analyzing charging demands and vehicle-to-vehicle (V2V) charging availability from collected data; identifying a potential EV providing charging service and an EV requiring charging service; broadcasting charging demands and V2V charging availability information to identify a potential EV providing charging service and an EV requiring charging service; matching the responded EV providing charging service and the EV requiring charging service; suggesting an optimal charging option based on current battery condition, service profile, and user profile; assigning the charging tasks to the EV providing charging service and conforming the deployed charging tasks to the matched EV requiring charging service; dispatching or instructing the EV providing charging service to travel to the place where the EV requiring charging service will meet with it for the charging service; calculating the charging cost, travel expenses, and sharing credits for participants; and generating payment plans based on the calculated battery rental cost, travel expenses, and sharing credits for collecting payments, and paying the related participants.

A method of SV2VC with IoT data analysis for automatically charging EVs with enhanced optimal charging service may also include enabling running time charging (wired/wireless) for both EVs providing charging service and EVs requiring charging service and allowing users (EV providing charging service and EV requiring charging service) to choose preferred partners.

A method of SV2VC with IoT data analysis for automatically charging EVs with enhanced optimal charging service may also include defining an SV2VC framework to share charging abilities between EVs and defining a new data structure to track, save, and process SV2VC related data. The SV2VC framework may collect and monitor IoT data in the SV2VC client and from the SV2VC server. The typical SV2VC data may include data relating to EVs providing charging service, EVs requiring charging service, service profiles, travel options, user profiles, SV2VC service status, etc.

Implementations of the invention involve the technical field of V2V communication and EV charging, and are therefore necessarily rooted in computer technology. For example, the steps of analyzing, by a processor set, charging demands and charging availability of the plurality of EVs from charging data; identifying, by the processor set, an EV providing charging service and an EV requiring charging service from the plurality of EVs based on the analyzing; matching, by the processor set, the EV providing charging service and the EV requiring charging service; determining, by the processor set, a location, such a via GPS, for the EV requiring charging service to receive charging service from the EV providing charging service; communicating, by the processor set, a charging task comprising the location to the EV providing charging service; and instructing, by the processor set, the EV providing charging service to travel to the location are computer-based and cannot be performed in the human mind. For example, measuring and communicating charging demands and charging availability between a plurality of EVs (in some cases, tens-of-thousands of EVs) while tracking EV location data via global positioning systems (GPS) corresponding to each EV amounts to more than merely implementing a generic computer as a tool to gather, analyze, and output data. Similarly, an SV2VC framework configured to monitor IoT data in the SV2VC clients associated with numerous EVs or user devices and from the SV2VC server including data relating to EVs would be impossible to accomplish on pen and paper. In particular, the speed at which the measuring and communication of data, including GPS location data, must be accomplished in order to effectuate the disclosed method, system, or computer program product would involve large-scale, continuous monitoring, calculation, and wireless communication of such data. These features would be impossible to accomplish on pen and paper and cannot be accomplished as a method of organizing human activity.

Aspects of the present invention overcome shortcomings of stationary EV charging stations and portable chargers by facilitating communication of charging availability and charging needs across many EVs. Aspects of the present invention overcome the shortcomings of stationary EV charging stations and portable chargers by identifying EVs providing charging service and EVs requiring charging service from the plurality of EVs based on an analysis of factors such as travel routes, vehicle origins, vehicle destinations, battery charge timing and capacity, etc. Similarly, aspects of the present invention overcome the shortcomings of stationary EV charging stations and portable chargers by matching EVs providing charging service and EVs requiring charging service; determining an optimal charging option of EVs requiring charging service; and communicating a charging task to the EV providing charging service to meet with the EV requiring charging service so that vehicle to vehicle charging may occur.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a smart vehicle to vehicle charging service code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

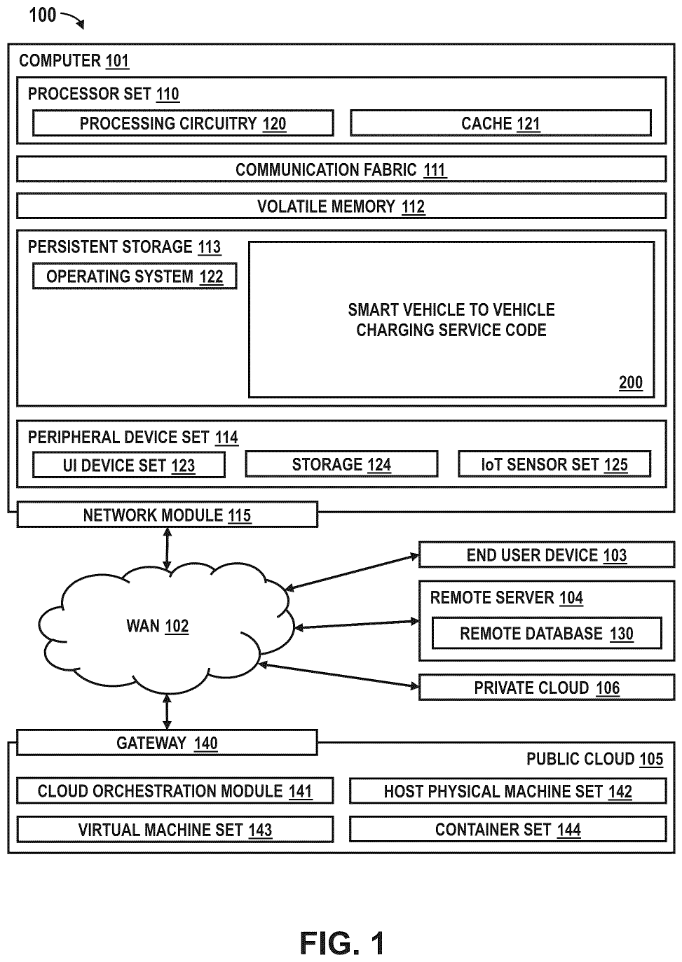

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

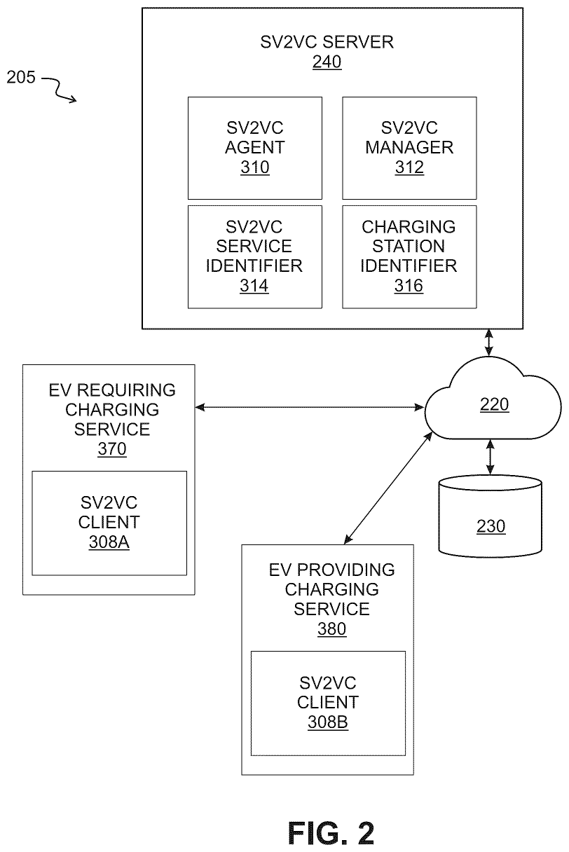

FIG. 2 shows a block diagram of an exemplary environment 205 in accordance with aspects of the invention. In embodiments, the environment includes SV2VC server 240, corresponding to computer 101 as in FIG. 1, including or in communication with modules including an SV2VC agent 310, an SV2VC manager 312, an SV2VC service identifier 314, and a charging station identifier 316, corresponding to smart vehicle to vehicle charging service (SV2VC) code of block 200 of FIG. 1.

In embodiments, the SV2VC agent 310, the SV2VC manager 312, the SV2VC service identifier 314, and the charging station identifier 316 each comprise one or more modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The SV2VC server 240 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

The SV2VC server 240 is in operable communication with the SV2VC clients 308A and 308B, each being a client-side software application installed on or associated with the EV providing charging service 380 or the EV requiring charging service 370. The SV2VC clients 308A and 308B may perform actions on behalf of the SV2VC server 240 on an EV or a user device, such as a smart device. The SV2VC clients 308A and 308B may be configured to provide access to and use of services provided by the SV2VC server 240. A database 230, corresponding to remote server 104 or remote database 130 of FIG. 1, may store user profile data, service profile data, SV2VC criteria, service availability data, location data, and payment, reward, and priority data.

In embodiments, the SV2VC agent 310 is configured to calculate a charging cost, a travel expense, and a sharing credit for the EV providing charging service 380 and the EV requiring charging service 370 and generating payment plans based on the charging cost, the travel expense, and the sharing credit. The SV2VC agent 310 may use a credit or ranking system to prioritize vehicles for many reasons, including past “generosity” in providing charging to others. Costs, expenses, and credits may be determined based on individual EV fuel economy, energy efficiency, energy rates, etc.

In embodiments, the SV2VC manager 312 is configured for collecting and storing EV data such as battery conditions, routing plans, current locations, and target destinations from a plurality of EVs in operable communication with WAN 220 corresponding to WAN 102 of FIG. 1, which may be a vehicle-to-everything (V2X) network. In various embodiments, a V2X network is a communication system configured to allow vehicles with network connections to interact with other vehicles, pedestrian devices, and roadway infrastructure devices, such as traffic lights, to improve vehicle safety and efficiency. The SV2VC manager 312 may be configured to analyze charging demands and charging availability of the plurality of EVs from the data, and communicate the charging demands and the charging availability to the plurality of EVs. The charging demands may include an EV's need for battery charging based on past, present, or predicted battery charge. For example, charging demand may be “high” when an EV has a low battery charge and is undertaking a long drive. Similarly, charging demands may be “low” when an EV has a full battery charge and is undertaking a short drive. The charging availability may include an EV's surplus battery charge compared to the EVs current trip and proximity to an EV with charging demands. For example, an EV may have “high” charging availability when the EV's battery has surplus charge compared to a current drive, and the EV is very near a second EV with charging demands. The SV2VC manager 312 may analyze charging demands based on the battery conditions, routing plans, current locations, and target destinations from a plurality of EVs. Analyzing charging demands may include statistical analysis, range prediction, energy rate expenditure estimates, etc. The charging availability may be determined based on the available charge of an EV providing charging service as determined by statistical analysis, range prediction, energy rate expenditure estimates, etc. The charging availability may also be determined by a user input via the SV2VC client such that a user may provide input via a human-to-machine interface confirming that their EV is available to provide charging service and the user is available to provide charging service. In embodiments, a user may provide input via a human-to-machine interface denying providing charging service. Additionally, the SV2VC manager 312 may be configured to match an EV providing charging service 380 and an EV requiring charging service 370 based on the analysis of charging demands and charging availability and enabling charging from the EV providing charging service 380 to the EV requiring charging service 370. The SV2VC manager 312 may include a data structure configured to track, save, and process smart vehicle-to-vehicle charging service data.

In embodiments, the SV2VC service identifier 314 is configured to: identify an EV providing charging service 380 and an EV requiring charging service 370 from the plurality of EVs based on analyzing charging demands and charging availability of the plurality of EVs from the data performed by the SV2VC manager 312; determine an optimal charging option of the EV requiring charging service 370, e.g., the nearest EV providing charging services 380; and communicate a charging task to the EV providing charging service 380, e.g., an alert or message communicated to the EV or device of an EV providing charging service 380. The charging task may include, for example, a routing plan to a location where the EV requesting charging service 370 and the EV providing charging service 380 may meet to perform vehicle-to-vehicle charging. The charging task may include information such as a charge level or state of the EV requesting charging service and identification information of the EV requesting charging service. The SV2VC service identifier 314 may also be configured to determine the optimal charging option based on the battery condition, the routing plan, the current location, the target destination, a service profile, and a user profile of the EV providing charging service 380 and the EV requiring charging service 370. In embodiments, the SV2VC service identifier 314 may update routing plans based on the charge, current location, the target destination, and the GPS data of an EV. Route planning may include shortest or fastest route planning based on GPS data, digital map data, and traffic data, such as by using a searching algorithm configured to find the shortest path between a first state and a final state. Routing plans may be continuously updated as the current location of an EV changes. In embodiments, the SV2VC service identifier 314 may also be configured to determine a location where the EV requiring charging service 370 will meet for charging service, and instruct the EV providing charging service to travel to the location, e.g., the location of the nearest EV providing charging services 380. Instructing the EV providing charging service to travel to the location may include communicating a command from the SV2VC server 302 to the human-to-machine interface of the EV to display the updated routing plan, such as via a GPS mapping function of a vehicle's infotainment system.

In embodiments, the charging station identifier 316 is configured to identify EV charging stations by availability, proximity, or cost by communicating with the EV charging station over WAN 220. For example, the charging station identifier 316 may identify EV charging stations based on GPS data, map data, and relative proximity of an EV to a charging station.

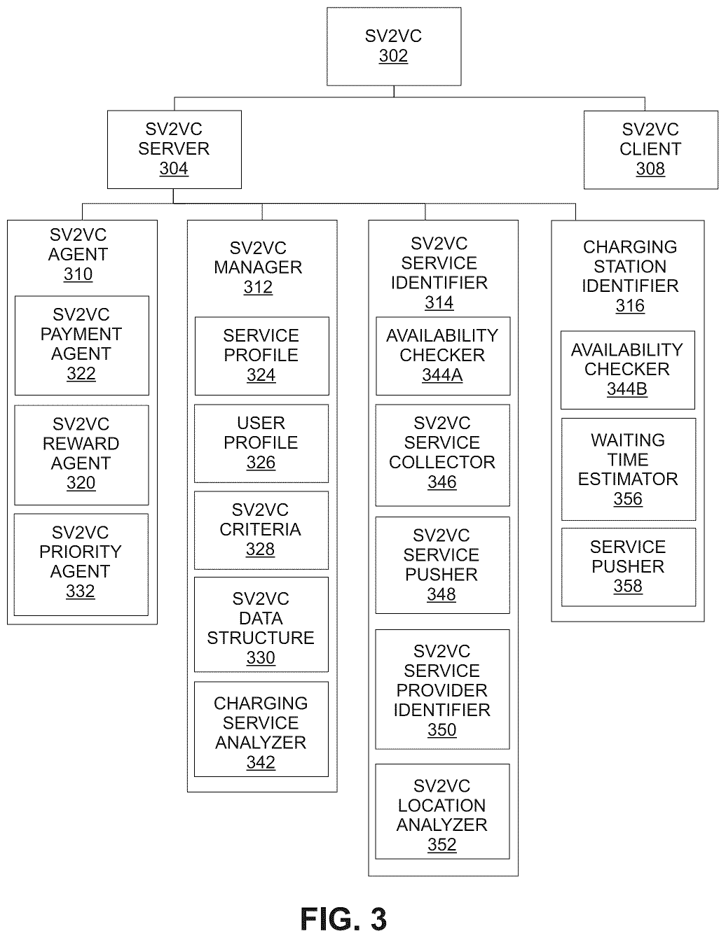

FIG. 3 shows a block diagram of an SV2VC 302 framework in accordance with aspects of the present invention. In embodiments, the SV2VC server 304 in FIG. 3 corresponds to the SV2VC server 240 of FIG. 2 and is in operable wireless communication with an SV2VC client 308 in operable communication with an EV or charging station. The SV2VC client 308 may monitor or receive EV or charging station data and communicate it to the SV2VC server 304 and vice versa in the operation of all functions performed by the SV2VC agent 310, the SV2VC manager 312, the SV2VC service identifier 314, and the charging station identifier 316.

The SV2VC agent 310 may be configured to calculate a charging cost, a travel expense, and a sharing credit for the EV providing charging service 380 and the EV requiring charging service 370 and generating payment plans based on the charging cost, the travel expense, and the sharing credit. The charging cost may be an estimated value, e.g., currency, of the charge provided by one EV to another EV. The travel expense may be an estimated value, e.g., currency, of the cost for an EV to travel to another EV to provide charge. The sharing credit may be a token system rewarding tokens to EVs providing charging services and may reward EVs providing or requesting charging services based on their tokens. A payment plan may be created based on the charging cost, for example, paying the charging cost over a fixed schedule. The SV2VC agent 310 may calculate charge, travel, and sharing credits based on proximity between EVs, electricity rates based on region, time, etc., time, weather, etc. The SV2VC agent 310 may include an SV2VC payment agent 322 for requesting and receiving charging costs and fees via wireless communication between EVs having linked banking accounts and functionality. The SV2VC agent 310 may include an SV2VC reward agent 320 and SV2VC priority agent 332 configured to track and record the providing of EV charging services, such as using tokens as sharing credits, and reward EVs providing or requesting charging services based on their tokens. As an example, an EV that has provided charging services often to other EVs in the past, may be prioritized when requesting EV charging services. The SV2VC reward agent 320 and the SV2VC priority agent 332 maintain and arrange a prioritized list of EVs based on numerous factors including the charging cost, travel expense, and sharing credits.

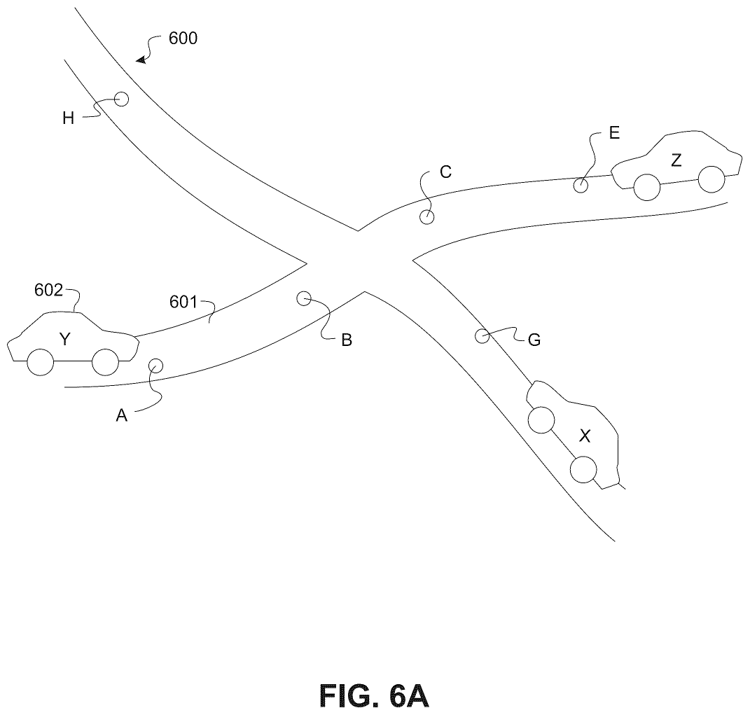

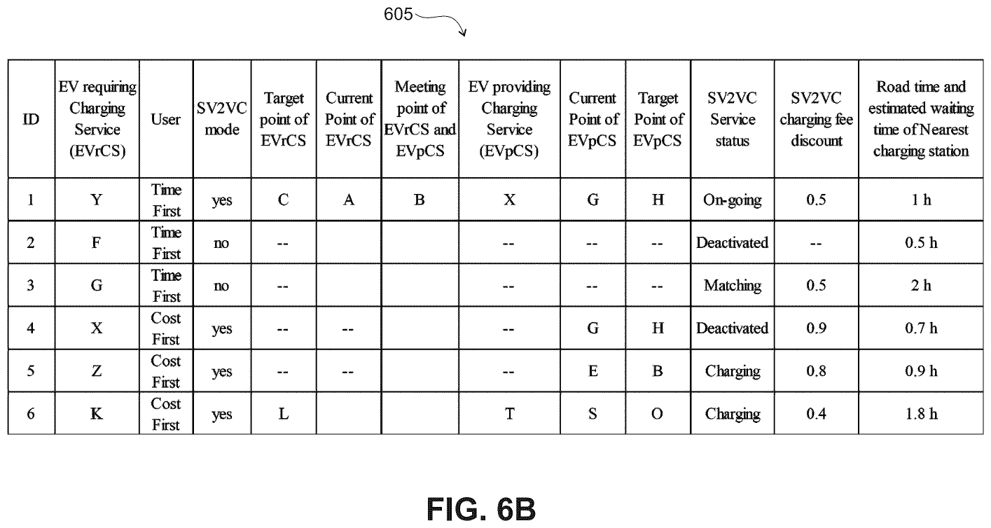

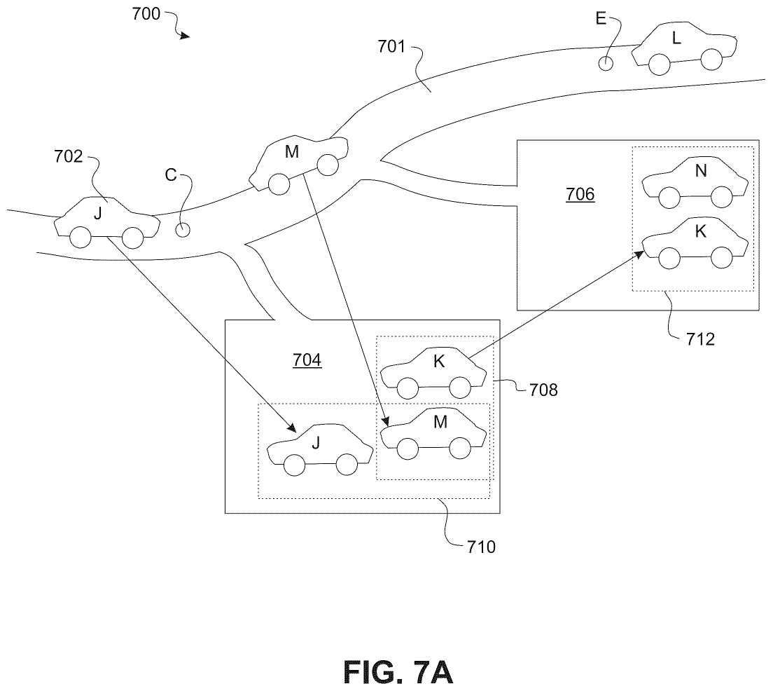

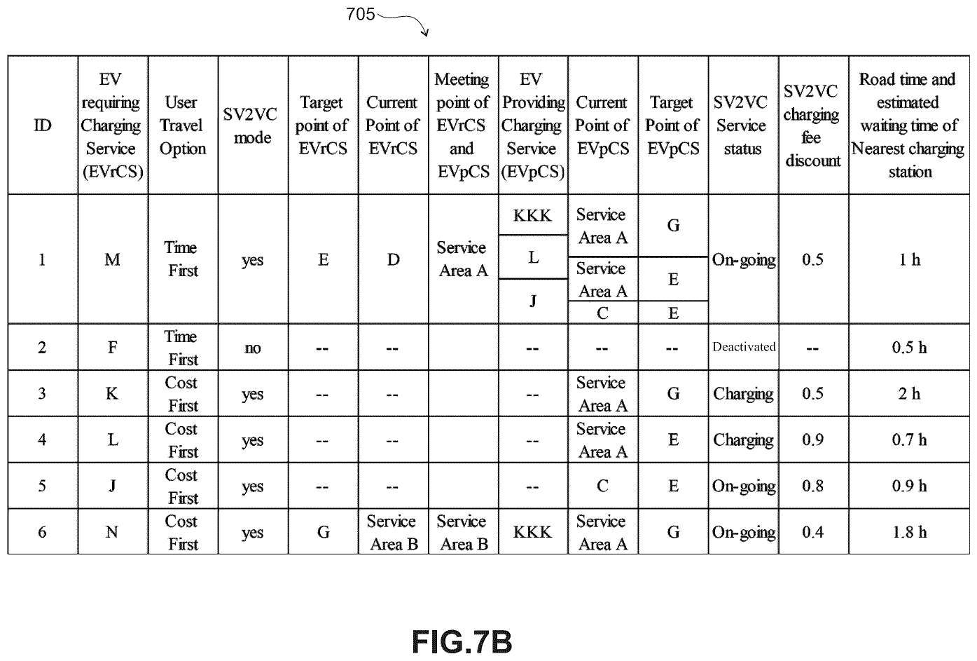

The SV2VC manager 312 is configured for collecting SV2VC criteria 328 such as battery conditions, routing plans, current locations, and target destinations from a plurality of EVs in operable communication with WAN 220. EV data may be compiled in a service profile 324 specific to individual EVs. The service profile 324 may include data relating to travel plans, speed, weather, air-conditioning, battery level, current location, and current time. A user profile 326 may also be compiled, including user data relating to driving habits and preferences, such as typical driving speeds, routes, times, etc. The SV2VC data structure 330 may store the SV2VC criteria 328, such as in the database 230 as in FIG. 2. Additionally, the SV2VC manager 312 may be configured for matching an EV providing charging service 380 and an EV requiring charging service 370 based on the analysis of charging demands and charging availability performed by the charging service analyzer 342. The charging service analyzer 342 may analyze data in the SV2VC criteria 328, the user profile 326, and the service profile 324 to identify similarities within the data sets to determine optimal charging options for an EV requiring charging service 370. The charging service analyzer 342 may utilize the user profile 326 and the service profiles 324 to identify or determine if charging service is needed by an EV based on predetermined thresholds of charge within a battery of an EV. Analysis performed by the charging service analyzer 342 may include, for example, data table analysis based on data types, column headers, statistical analysis, classification, or regression analysis. Exemplary data tables including the SV2VC criteria 328, the user profile 326, and the service profile 324 are depicted in FIGS. 6B and 7B.

The SV2VC service identifier 314 is configured to identify an EV providing charging service 380 and an EV requiring charging service 370 from the plurality of EVs based on analyzing charging demands and charging availability of the plurality of EVs from the data performed by the SV2VC manager 312. The SV2VC service identifier 314 may include an availability checker 344A configured to communicate over the WAN 220 of FIG. 2 with EVs available to provide charging service. The availability checker 344A may receive information relating to whether a charging station or EV is already providing charge to an EV. In some embodiments, the availability checker 344A may be based on the proximity of EVs to one another or a charging station, as determined based on GPS coordinates or location tracking. An SV2VC service collector 346 may compile EVs available to provide charging service, such as in the database 230 of FIG. 2, and, in combination with an SV2VC service pusher 348, communicate the availability of charging options to an EV. An SV2VC service provider identifier 350 may identify a final service charging provider based on the availability checker 344A, the SV2VC service collector 346, and an SV2VC location analyzer 352. In particular, the SV2VC location analyzer 352 is configured to communicate with the GPS of EVs to determine EV locations. The SV2VC service provider identifier 350 may finalize a final service charging provider by confirming a requirement for charging and a provider for charging, such as determining an optimal charging option of the EV requiring charging service 370 of FIG. 2, e.g., the nearest EV providing charging services 380 as determined by the SV2VC location analyzer 352. The SV2VC service provider identifier 350 may communicate a charging task to the EV providing charging service 380 via the SV2VC service pusher 348, e.g., an alert or message communicated to the EV or device of an EV providing charging service 380. The charging task may include information such as a charge level or state of the EV requesting charging service, a meeting location, a routing plan, identification information of the EV requesting charging service, etc. In this manner, the SV2VC service identifier 314 is configured to determine the optimal charging option based on the battery condition, the routing plan, the current location, the target destination, a service profile, and a user profile of the EV providing charging service 380 and the EV requiring charging service 370. A charging option may include a charging source, i.e., a charging station or an EV providing charging service. An optimal charging option may be, for example, a charging source that is nearest to an EV requesting charging service. Alternatively, an optimal charging option may be, for example, a charging source that provides charge at a comparatively low cost (dollars per kilowatt) to an EV requesting charging service. For example, the optimal charging option may be an option selected from between a nearest EV or a nearest charging station and their respective costs as charging options available to an EV requesting charging service. Determining the optimal charging option may include computer-based analytics of smart vehicle-to-vehicle charging service data, as depicted in the tables of FIGS. 6B and 7B. Determining the optimal charging option may include, for example, descriptive analytics with respect to user and service profiles, diagnostic analytics with respect to EV charge, predictive analytics with respect to planned route and GPS data, prescriptive analytics based on charging demands and availability, real-time analytics with respect to EV travel time and speed, and spatial analytics with respect to GPS data, etc. Similarly, in this manner, the SV2VC service identifier 314 may also be configured to determine a location where the EV requiring charging service 370 will meet for charging service, and instruct the EV providing charging service 380 to travel to the location, e.g., the location of the nearest EV providing charging services 380.

The charging station identifier 316 is configured to identify EV charging stations by availability, proximity, or cost by communicating with the EV charging station over the WAN 220 of FIG. 2. Availability may be determined via an availability checker 344B, which is configured to communicate over the WAN 220 with charging stations available to provide charging service. Availability may be determined by the availability checker 344B based on the waiting time for charging at a charging station. Further, a wait time may be received by the waiting time estimator 356 from a charging station. A service pusher 358 may communicate the availability of a charging station from the SV2VC server 304 to an EV. In this manner, the charging station identifier 316 may identify EV charging stations based on availability, waiting time, GPS data, map data, and relative proximity of an EV to a charging station.

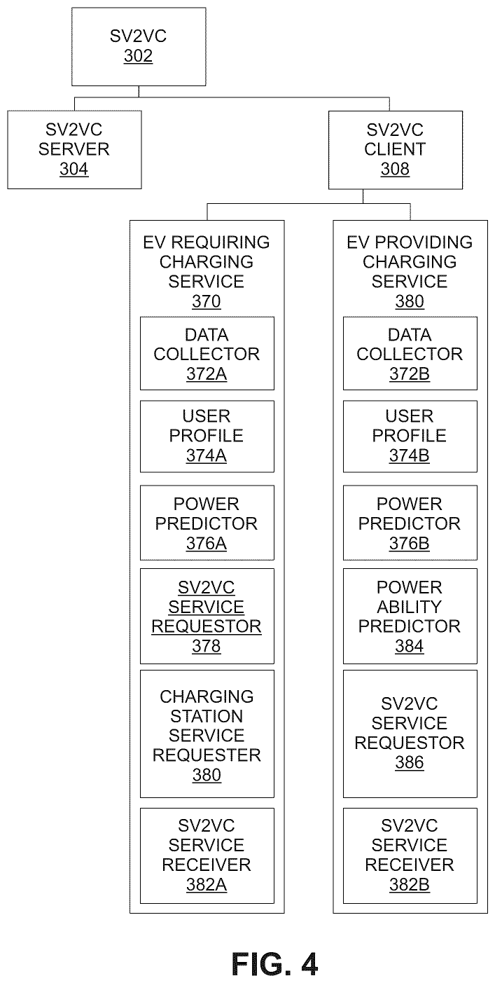

FIG. 4 shows a block diagram of an SV2VC 302 framework, depicted as SV2VC 302 framework of FIG. 3, in accordance with aspects of the present invention. The SV2VC server 304, depicted as SV2VC server 304 of FIG. 3, may in operable wireless communication with the SV2VC client 308, depicted as SV2VC client 308 of FIG. 3, in operable communication with an EV or charging station. The SV2VC client 308 may monitor or receive EV or charging station data and communicate it to the SV2VC server 304 and vice versa. In embodiments, the SV2VC client 308 may be in operable communication with the EV providing charging service 380 and the EV requiring charging service 370. In embodiments, the SV2VC client 308 may be a software application installed on a computer device integrated into the EV providing charging service 380 or the EV requiring charging service 370.

The EV requiring charging service 370 includes a data collector 372A configured to compile data from EV software, sensor suites, and on-board EV systems to be communicated to the SV2VC server 304 for use. The EV requiring charging service 370 may also include a user profile 374A specific to the user of an EV or the EV itself. The user profile 374A may include data defining mileage anxiety, EV charging threshold, max distance to nearby EV providing charging service 380, max distance to nearby EV requiring charging service 370, charging time, charging capacity, and maximum waiting time. The EV requiring charging service 370 may include a power predictor 376A configured to measure or receive, from the EV, data relating to EV range or rate of energy use, in order to determine EV battery charge state or capacity. The EV requiring charging service 370 may include an SV2VC service requestor 378 configured to communicate a charging service request to an EV providing charging service 380 or a charging station by communicating a request to the SV2VC client 308 or the SV2VC server 304 to determine charging availability. Based on the request, such as in the case of a response indicating that an EV providing charging service 380 is not available, a charging station service requestor 380 may communicate a request to the SV2VC client 308 or the SV2VC server 304 to push a service request to a charging station. In response to the service request, an SV2VC service receiver 382A may receive a return confirmation via the SV2VC client 308 or the SV2VC server 304 that an EV providing charging service 380 or a charging station is available to provide charging service.

The EV providing charging service 380 may include a data collector 372B, user profile 374B, power predictor 376B, power ability predictor 384, SV2VC service requestor 386, and SV2VC service receiver 382B similar in construction and function to the data collector 372A, user profile 374A, power predictor 376A, SV2VC service requestor 378, charging station service requester 380, and SV2VC service receiver 382A of the EV requiring charging service 370. The EV providing charging service 380 may include a power ability predictor 384 configured to estimate, based on the user profile and the service profile of an EV, the capacity of the EV providing charging service 380 to provide charge to the EV requiring charging service 370. Estimating the capacity to provide charge may be based on user input, estimates on charge required for the EV providing charging service's 380 current trip, current battery state, battery charge expense rate, etc.

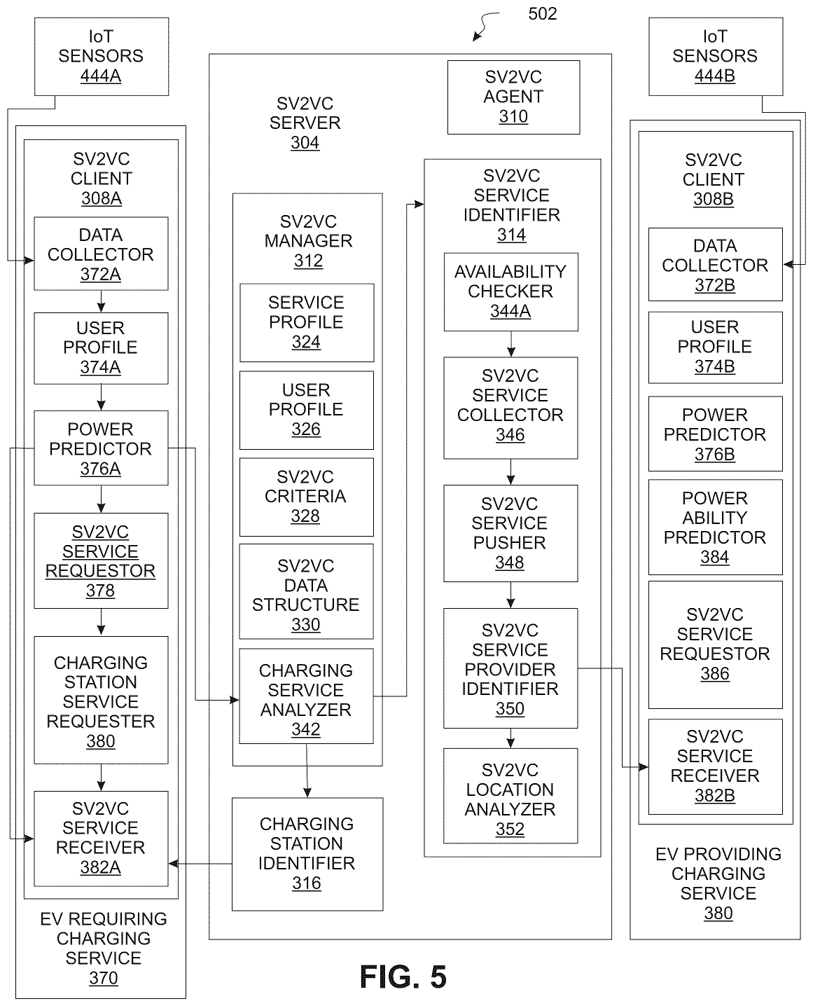

FIG. 5 shows a block diagram of an exemplary environment 502 in accordance with aspects of the present invention. An EV requiring charging service 380 and an EV providing charging service 380, as shown in FIGS. 2 and 4, each including an SV2VC client 308A and 308B, respectively, may be in operable communication with the SV2VC server 304 to coordinate V2V charging. IoT sensors 444A and IoT sensors 444B may be sensor suites specific to the EV requiring charging service 370 and an EV providing charging service 380, respectively, to facilitate data collectors 372A, 372B compiling data from EV software, sensor suites, and on-board EV systems to be communicated to the SV2VC server 304.

The EV requiring charging service 370 includes a data collector 372A configured to compile data from EV systems to be communicated to the SV2VC server 304. The EV requiring charging service 370 may also include a user profile 374A. and a power predictor 376A configured to determine EV battery charge state or capacity.

The power predictor 376A is in operable communication with the charging service analyzer 342, which may analyze data in the SV2VC criteria 328, user profile 326, and the service profile 324 to identify similarities within the data sets to determine optimal charging options for the EV requiring charging service 370. The charging service analyzer 342 may use user profile 326 and service profiles 324 to identify or determine if charging service is needed by an EV based on predetermined thresholds of charge within a battery of an EV. The power predictor 376A may be in operable communication with the SV2VC service receiver 382A to communicate with the charging station identifier 316. The power predictor 376A may communicate a need for a charging service based on predetermined thresholds of charge within a battery of an EV may be communicated to the SV2VC server 304 via the SV2VC manager 213. The SV2VC manager 312 may be configured for matching an EV providing charging service 380 and an EV requiring charging service 370 based on the analysis of charging demands and charging availability performed by the charging service analyzer 342. The charging demands and charging availability may be used by the SV2VC service identifier 314 for determining the optimal charging option based on the battery condition, the routing plan, the current location, the target destination, a service profile, and a user profile of the EV providing charging service 380 and the EV requiring charging service 370.

As depicted in FIG. 5, an EV requiring charging service 370 may include an SV2VC service requestor 378 configured to communicate a charging service request to an EV providing charging service 380, such as by communicating a request to the SV2VC client 308B or the SV2VC server 304 to determine charging availability. Based on the charging service request, an EV providing charging service 380 may communicate a request to the SV2VC client 308B or the SV2VC server 304 to push a service request to an EV providing charging service 380 via the SV2VC service provider identifier. In response to the service request, an SV2VC service receiver 382B may receive a return confirmation via the SV2VC client 308B or the SV2VC server 304 that an EV providing charging service 380 is available to provide charging service.

The EV providing charging service 380 includes a data collector 372B, user profile 374B, power predictor 376B, SV2VC service requestor 386, and SV2VC service receiver 382B similar in construction and function to the data collector 372A, user profile 374A, power predictor 376A, SV2VC service requestor 378, charge station service requester 380, and SV2VC service receiver 382A of the EV requiring charging service 370.

FIG. 6A shows an exemplary environment 600 in accordance with aspects of the present invention. As an example, a vehicle 602, such as vehicle Y, may be driving on a roadway 601 from point A to Point C. Simultaneously, vehicle Z may be driving on the roadway 601 from point E to point B. Additionally, vehicle X may be driving on the roadway 601 from point G to point H. The IoT sensors of vehicle Y, depicted as IoT sensors 444A and 444B in FIG. 5, may determine or detect that the battery charge level of vehicle Y is lower than a charging threshold required for vehicle Y to reach point C. Accordingly, vehicle Y may need a charging service. As determined via the SV2VC service identifier 314 of FIG. 5, nearby charging stations at point B are occupied with other vehicles or have long wait times and will be unavailable as a charging option. Additionally, the IoT sensors of vehicle Z have sufficient charge as determined by the power ability predictor 384 of FIG. 5. The SV2VC server 304 or the SV2VC client 308A of FIG. 5 of vehicle Y may make a request for service indicating that vehicle Y requires vehicle to vehicle charging and the user is willing and prepared to pay a charging cost and fees to a vehicle providing a charger service via the SV2VC service requestor 378 of FIG. 5. The SV2VC server may identify vehicle Z as a potential charging service provider based on the sufficient charge identified by the power ability predictor 384 of FIG. 5. Alternatively, the SV2VC server may determine that vehicle Z is a potential charging service provider based on proximity, prior charging service participation, etc. As an example, vehicle Z may reject the charging service request via user input on the SV2VC client 308 of vehicle Z. Accordingly, the SV2VC server may request charging service from a sub-optimal candidate, such as vehicle X, and which vehicle X may accept via an SV2VC client 308B of FIG. 5 of vehicle X. Upon acceptance, the SV2VC server may determine an optimal meeting point on the roadway 601 between vehicle Y and vehicle X based on distance and available battery charge of both vehicles via the SV2VC service identifier 314 of FIG. 5. Vehicle Y and vehicle X may travel to the meeting point, such as point B, where vehicle X may function as the EV providing charging service to vehicle Y, the EV requiring charging service 370 of FIG. 5. In some embodiments, the SV2VC agent 310 of FIG. 5 may record vehicle X's service as a charge provider via a token system and provide charging preference to vehicle X in a hierarchy of EVs receiving or providing charging service stored on the SV2VC server. SV2VC agent 310 may also function as a payment portal between vehicle Y and vehicle X, in the event that vehicle requires vehicle Y to pay for rendered charging services.

FIG. 6B shows a table of smart vehicle-to-vehicle charging service data 605 in accordance with aspects of the present invention, and with respect to the exemplary environment 600 of FIG. 6A and the example described with respect to FIG. 6A. The smart vehicle-to-vehicle charging service data 605 may be stored in the database 230 of FIG. 2. The smart vehicle-to-vehicle charging service data 605 may include EV's (ID) and EV identifiers (EVrCS). The smart vehicle-to-vehicle charging service data 605 may include user input preferences (User) in the user profile 326 of FIG. 3. The smart vehicle-to-vehicle charging service data 605 may include SV2VC modes, indicative of whether an EV is participating in smart vehicle-to-vehicle charging as provided by the SV2VC 302 of FIG. 3. The smart vehicle-to-vehicle charging service data 605 may also include target points, current points, and meeting points, e.g., locations, for EVICS. The smart vehicle-to-vehicle charging service data 605 may include EVs providing charging services and their target points, current points, and meeting points, e.g., locations. The smart vehicle-to-vehicle charging service data 605 may include charging or service status indicators (SV2VC Service status), tokens or charging fee discounts determined by the SV2VC agent 310 of FIG. 3, and road time and estimated waiting time of a nearest charging station as determined by the charging station identifier 316 of FIG. 3.

FIG. 7A shows an exemplary environment 700 in accordance with aspects of the present invention. As an example, vehicle 702, such as vehicle J may be traveling on roadway 701 from point D to point E and may arrive at service area 704, which may include a charging station. Similarly, vehicle M may be driving on roadway 701 from point C to point E and may arrive at service area 704, which may include a charging station. Vehicle K may be parked in service area 704. Additionally, vehicle N may be parked at service area 706, which may also include a charging station. The IoT sensors of vehicle J, corresponding to IoT sensors 444A of FIG. 5, may indicate that the battery charge level of vehicle J is lower than a charging threshold when vehicle J arrives at service area 704. In other words, vehicle J requires charging service. However, service area 704 may include EV charging stations that are currently occupied, disabled, or otherwise unavailable. The IoT sensors of vehicle J may communicate with the SV2VC server 302 via SV2VC client 308A of FIG. 2 to identify vehicles K and vehicle M as potential EVs providing charging service 380 of FIG. 2, which may include SV2VC client 308B of FIG. 2. The SV2VC server may communicate requests to vehicle K and vehicle M requesting charging service for vehicle J. Vehicle K and vehicle M may respond to the request indicating that they are available to provide charging services to vehicle J. In embodiments, the request may be a notification or ping sent to the SV2VC client of vehicles K and M. Vehicles K and M may accept or deny the request via the SV2VC client. In embodiments, the SV2VC server 302 communicates charging service requests to vehicles K and M prior to vehicle J's arrival at service area 704. Vehicle K and vehicle J may be a matched charging pair 708, as identified by the SV2VC manager 312 of FIGS. 4 and 5, of the SC2VC server. Similarly, vehicle J and vehicle M may be a matched charging pair 710. Additionally, the SV2VC server 302 may communicate to vehicle K that a charging station is available at service area 706, or that vehicle N is available as a charging service provider. Availability of charging stations or EVs providing charging service may be communicated to the EV requesting charging services via SV2VC clients, and in embodiments, displayed on a user interface of an EVs dashboard, human-to-machine interface, or UI device set 123 of FIG. 1. For example, a UI device set 123 may include a human-to-machine interface such as a vehicle infotainment system. Alternatively, human-to-machine interface may be instructed, via a command from the SV2VC server 302, to display the updated routing plan. In embodiments, EV's providing charging service, such as EV providing charging service 380 of FIG. 3, may be grouped into available EV charging pools 712 via the SV2VC manager 312 and the SV2VC service identifier 314 of FIG. 3. In some embodiments, vehicle L is identified as a potential charging service provider but does not receive a charging service request due to vehicle L's distance from vehicle M or vehicle K. Vehicle L may be eliminated as a potential charging service provider based on the SV2VC service identifier.

FIG. 7B shows a table of smart vehicle-to-vehicle charging service data 705 in accordance with aspects of the present invention, and with respect to the exemplary environment 700 of FIG. 7A and the example described with respect to FIG. 7A. The smart vehicle-to-vehicle charging service data 705 may be stored in the database 230 of FIG. 2. The smart vehicle-to-vehicle charging service data 705 may include EV's (ID) and EV identifiers (EVrCS). The smart vehicle-to-vehicle charging service data 705 may include user input preferences (User Travel Option) in the user profile 326 of FIG. 3. The smart vehicle-to-vehicle charging service data 705 may include SV2VC modes, indicative of whether an EV is participating in smart vehicle-to-vehicle charging as provided by the SV2VC 302 of FIG. 3. The smart vehicle-to-vehicle charging service data 705 may also include target points, current points, and meeting points, e.g., locations, for EVrCS. The smart vehicle-to-vehicle charging service data 705 may include EVs providing charging services and their target points, current points, and meeting points, e.g., locations. The smart vehicle-to-vehicle charging service data 705 may include charging or service status indicators (SV2VC Service status), tokens or charging fee discounts determined by the SV2VC agent 310 of FIG. 3, and road time and estimated waiting time of a nearest charging station as determined by the charging station identifier 316 of FIG. 3.

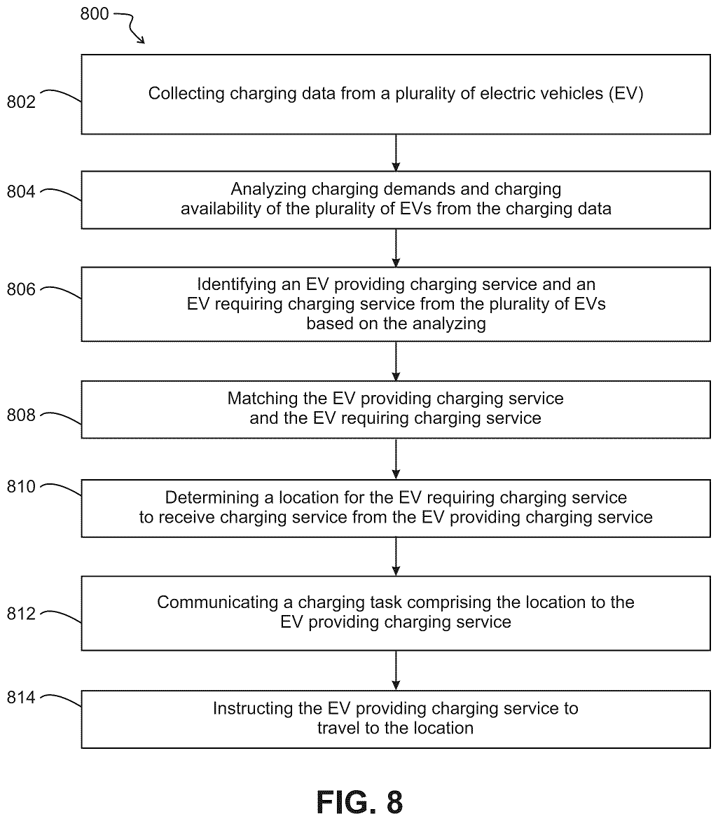

FIG. 8 shows a flowchart of an exemplary method 800 in accordance with aspects of the present invention. According to aspects of the invention, step 802 may include collecting charging data from a plurality of electric vehicles (EV) via the SV2VC manager 312 of FIG. 2. Step 804 may include analyzing charging demands and charging availability of the plurality of EVs from the data via the SV2VC manager 312 of FIG. 2. Step 806 may include identifying an EV providing charging service and an EV requiring charging service from the plurality of EVs based on the analyzing; via the SV2VC service identifier 314 of FIG. 2. Step 808 may include matching the EV providing charging service and the EV requiring charging service via the SV2VC service identifier 314 of FIG. 2. Step 810 may include determining a location for the EV requiring charging service to receive charging service from the EV providing charging service via the SV2VC service identifier 314 of FIG. 2. Step 812 may include communicating a charging task comprising the location to the EV providing charging service via the SV2VC service identifier 314 of FIG. 2. Step 814 may include instructing the EV providing charging service to travel to the location via the SV2VC service identifier 314 of FIG. 2.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
collecting, by a processor set, charging data from a plurality of electric vehicles (EV);
analyzing, by the processor set, charging demands and charging availability of the plurality of EVs from the charging data;
identifying, by the processor set, an EV providing charging service and an EV requiring charging service from the plurality of EVs based on the analyzing;
matching, by the processor set, the EV providing charging service and the EV requiring charging service;
determining, by the processor set, a location for the EV requiring charging service to receive charging service from the EV providing charging service;
communicating, by the processor set, a charging task comprising the location to the EV providing charging service; and
instructing, by the processor set, the EV providing charging service to travel to the location.

2. The computer-implemented method of claim 1, further comprising:
determining an optimal charging option of the EV requiring charging service; and
determining an optimal charging option of the EV providing charging service.

3. The computer-implemented method of claim 2, wherein the determining the optimal charging option of the EV requiring charging service comprises performing analytics on the charging data, the analytics selected from a group consisting of descriptive analytics, diagnostic analytics, predictive analytics, prescriptive analytics, real-time analytics, and spatial analytics.

4. The computer-implemented method of claim 3, wherein the optimal charging option of the EV requiring charging service comprises wired vehicle-to-vehicle charging.

5. The computer-implemented method of claim 3, wherein the optimal charging option of the EV requiring charging service comprises wireless vehicle-to-vehicle charging.

6. The computer-implemented method of claim 1, wherein the charging task comprises a routing plan to the EV requiring charging service.

7. The computer-implemented method of claim 1, further comprising updating a data structure configured to track, save, and process smart vehicle-to-vehicle charging service data.

8. The computer-implemented method of claim 1, wherein the charging data comprises a battery condition, a current location, and a target destination.

9. The computer-implemented method of claim 1, further comprising calculating a charging cost, a travel expense, and a sharing credit for the EV providing charging service and the EV requiring charging service.

10. The computer-implemented method of claim 9, further comprising generating payment plans based on the charging cost, the travel expense, and the sharing credit.

11. A computer program product comprising one or more computer readable storage media having program instructions collectively stored on the one or more computer readable storage media, the program instructions executable to:
collect charging data from a plurality of electric vehicles (EV);
analyze charging demands and charging availability of the plurality of EVs from the charging data;
identify an EV providing charging service and an EV requiring charging service from the plurality of EVs based on the analyzing;
match the EV providing charging service and the EV requiring charging service;
determine a location for the EV requiring charging service to receive charging service from the EV providing charging service;
communicate a charging task comprising the location to the EV providing charging service; and
instruct the EV providing charging service to travel to the location.

12. The computer program product of claim 11, wherein the program instructions are further executable to:
determine an optimal charging option of the EV requiring charging service; and
determine an optimal charging option of the EV providing charging service.

13. The computer program product of claim 12, wherein the determining the optimal charging option of the EV requiring charging service comprises performing analytics on the charging data, the analytics selected from a group consisting of descriptive analytics, diagnostic analytics, predictive analytics, prescriptive analytics, real-time analytics, and spatial analytics.

14. The computer program product of claim 13, wherein the optimal charging option of the EV requiring charging service comprises wired vehicle-to-vehicle charging.

15. The computer program product of claim 13, wherein the optimal charging option of the EV requiring charging service comprises wireless vehicle-to-vehicle charging.

16. The computer program product of claim 11, wherein the charging task comprises a routing plan to the EV requiring charging service.

17. The computer program product of claim 11, wherein the program instructions are further executable to update a data structure configured to track, save, and process smart vehicle-to-vehicle charging service data.

18. The computer program product of claim 11, wherein the charging data comprises a battery condition, a current location, and a target destination.

19. The computer program product of claim 11, wherein the program instructions are further executable to calculate a charging cost, a travel expense, and a sharing credit for the EV providing charging service and the EV requiring charging service.

20. A system comprising:
a processor set, one or more computer readable storage media, and program instructions collectively stored on the one or more computer readable storage media, the program instructions executable to:
collect charging data from a plurality of electric vehicles (EV);
analyze charging demands and charging availability of the plurality of EVs from the charging data;
identify an EV providing charging service and an EV requiring charging service from the plurality of EVs based on the analyzing;
match the EV providing charging service and the EV requiring charging service;
determine a location for the EV requiring charging service to receive charging service from the EV providing charging service;
communicate a charging task comprising the location to the EV providing charging service; and
instruct the EV providing charging service to travel to the location.
